(19) United States
(12) Patent Application Publication
(10) Pub. No.: US 2018/0204674 A1
(43) Pub. Date: Jul. 19, 2018

(54) WIRELESS POWER TRANSMISSION MODULE AND ELECTRONIC DEVICE INCLUDING THE SAME

(71) Applicant: Samsung Electro-Mechanics Co., Ltd., Suwon-si (KR)

(72) Inventors: Jung Young CHO, Suwon-si (KR); Tae Jun CHOI, Suwon-si (KR); Jeong Ki RYOO, Suwon-si (KR); Seung Min LEE, Suwon-si (KR); Chang Hak CHOI, Suwon-si (KR); Doo Ho PARK, Suwon-si (KR)

(73) Assignee: Samsung Electro-Mechanics Co., Ltd., Suwon-si (KR)

(21) Appl. No.: 15/704,788

(22) Filed: Sep. 14, 2017

(30) Foreign Application Priority Data
Jan. 13, 2017 (KR) 10-2017-0006319
Mar. 23, 2017 (KR) 10-2017-0037033

(51) Int. Cl. H01F 38/14; H01F 27/28; H01F 27/24

(52) U.S. Cl. CPC H01F 38/14; H02J 7/025; H01F 27/24; H01F 27/28

(57) ABSTRACT

A wireless power transmission module includes a coil portion having a spiral form and including a hollow portion; and a magnetic portion including a coil accommodation portion in which the coil portion is disposed, the coil accommodation portion being formed as a hollow space in an upper surface of the magnetic portion, and having a bowl form having a greatest width at the upper surface of the magnetic portion; and a magnetic field concentration portion protruding upwardly from a central portion of the coil accommodation portion through the hollow portion of the coil portion.

### CROSS-REFERENCE TO RELATED APPLICATIONS

This application claims the benefit under 35 USC 119(a) of Korean Patent Application Nos. 10-2017-0006319 filed on Jan. 13, 2017, and 10-2017-0037033 filed on Mar. 23, 2017, in the Korean Intellectual Property Office, the entire disclosures of which are incorporated herein by reference for all purposes.

### BACKGROUND

### 1. Field

The following description relates to a wireless power transmission module and an electronic device including the same.

### 2. Description of Related Art

Wireless power transmission technologies have commonly been applied to various electronic devices, such as communications terminals, portable terminals, smartphones, and wearable devices.

Types of wireless power transmission technology may mainly be divided into an electromagnetic induction method using coils, and a magnetic resonance method using resonance. Among these methods, a power transmission method using magnetic induction is provided as a method of transmitting power between a primary coil and a secondary coil.

When a magnet is moved in a coil, an induced current is generated in the coil. A sending terminal generates a magnetic field using the induced current, causing an electric current to be induced in a receiving terminal in response to changes in the magnetic field, thereby generating energy. Such a phenomenon is referred to as a magnetic induction phenomenon. A power transmission method using the magnetic induction phenomenon has a high energy transmission efficiency.

However, power transmission modules of the related art have limited charging distances and areas.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a wireless power transmission module includes a coil portion having a spiral form and including a hollow portion; and a magnetic portion including a coil accommodation portion in which the coil portion is disposed, the coil accommodation portion being formed as a hollow space in an upper surface of the magnetic portion, and having a bowl form having a greatest width at the upper surface of the magnetic portion; and a magnetic field concentration portion protruding upwardly from a central portion of the coil accommodation portion through the hollow portion of the coil portion.

An end portion of the magnetic field concentration portion may be coplanar with the upper surface of the magnetic portion.

At least a portion of the coil portion may be disposed on an internal surface of the coil accommodation portion.

A portion of the coil portion may be wound around at least a portion of an outer circumferential surface of the magnetic field concentration portion.

A cross-sectional area of the magnetic field concentration portion may increase or decrease in a direction toward an end portion of the magnetic field concentration portion.

The magnetic portion may include a base portion forming a bottom of the coil accommodation portion; and a sidewall portion disposed along a perimeter of the base portion and forming an external side surface of the coil accommodation portion.

The coil portion may include a spiral portion having a spiral form; and an outlet portion extending from opposite ends of the spiral portion and exiting from the magnetic portion; and the magnetic portion may include either one or both of an outlet groove and an outlet hole enabling the outlet portion to exit from the magnetic portion.

The outlet hole may penetrate through the sidewall portion of the magnetic portion.

The outlet hole may penetrate through the base portion of the magnetic portion.

The wireless power transmission module may further include a guide groove formed in a bottom surface of the magnetic portion and connecting the outlet hole to an outer circumferential surface of the sidewall portion.

A material of the magnetic field concentration portion may be different from either one or both of a material of the base portion and a material of the sidewall portion.

The coil accommodation portion may include an inclined side surface and a flat bottom surface.

The magnetic field concentration portion may include a flat end portion.

In another general aspect, a wireless power transmission module includes a coil portion having a solenoid form and including a hollow portion, wherein an upper end and a lower end of the coil portion have different internal diameters; and a magnetic portion combined with the coil portion and including a magnetic field concentration portion combined with the coil portion and having a pillar form penetrating through the hollow portion of the coil portion. wherein a height of the magnetic field concentration portion is equal to a height of the coil portion.

In another general aspect, an electronic device includes a case; and a wireless power transmission module disposed in the case and including a coil portion having a solenoid form and including a hollow portion, wherein an upper end and a lower end of the coil portion have different internal diameters; and a magnetic portion including a coil accommodation portion in which the coil portion is disposed, the coil accommodation portion being formed as a hollow space in an upper surface of the magnetic portion, and having a bowl form having a greatest width at the upper surface of the magnetic portion; and a magnetic field concentration portion protruding upwardly from a central portion of the coil accommodation portion through the hollow portion of the coil portion.

A portion of the coil portion may be wound around at least a portion of an outer circumferential surface of the magnetic field concentration portion.

In another general aspect, a wireless power transmission module includes a magnetic portion including a coil accommodation portion formed as a hollow space in an upper surface of the magnetic portion, wherein a cross-sectional area of the hollow space increases in a direction from a bottom of the hollow space to the upper surface of the magnetic portion; an a magnetic field concentration portion disposed on a bottom surface of the coil accommodation portion; and a coil portion disposed on a surface of the coil accommodation portion without covering an upper end of the magnetic field concentration portion.

The hollow space may have a conical form in which a diameter of the hollow space linearly increases from the bottom of the hollow space to the upper surface of the magnetic portion.

A cross-sectional area of the magnetic field concentration portion may increase or decrease from a lower end of the magnetic field concentration portion disposed on the bottom surface of the coil accommodation portion to an upper end of the magnetic field concentration portion.

The wireless power transmission module may further include a voltage converting portion configured to convert AC or DC power received from an external source to AC power having a wireless power transmission frequency, and apply the AC power having the wireless power transmission frequency to the coil portion to transmit wireless power.

In another general aspect, a wireless power transmission module including a magnetic portion including a coil accommodation portion formed as a hollow space in an upper surface of the magnetic portion and including a flat bottom surface and an inclined surface extending from the flat bottom surface to the upper surface of the magnetic portion; and a magnetic field concentration portion disposed on the flat bottom surface of the coil accommodation portion; and a coil portion disposed at least on the inclined surface of the coil accommodation portion without covering an upper end of the magnetic field concentration portion.

The magnetic field concentration portion may fill substantially an entire volume of the coil accommodation portion not occupied by the coil portion.

A first portion of the coil portion may be disposed on the inclined surface of the coil accommodation portion; and a second portion of the coil portion may be wound around at least a portion of a circumferential side surface of the magnetic field concentration portion.

An area of the flat bottom surface of the coil accommodation portion may be greater than a cross-sectional area of a bottom end of the magnetic field concentration portion; a first portion of the coil portion may be disposed on the inclined surface of the coil accommodation portion; and a second portion of the coil portion may be disposed on a portion of the flat bottom surface of the coil accommodation portion not covered by the magnetic field concentration portion.

Other features and aspects will be apparent from the following detailed description, the drawings, and the claims.

### BRIEF DESCRIPTION OF DRAWINGS

FIG. 1 is a schematic perspective view of examples of an electronic device.

FIG. 2 is a cross-sectional view taken along the line II-II′ of FIG. 1.

FIG. 3 is a schematic perspective view of an example of a wireless power transmission module.

FIG. 4 is a cross-sectional view taken along the line IV-IV′ of FIG. 3.

FIG. 5 is an exploded perspective view of the wireless power transmission module illustrated in FIG. 3.

FIGS. 6A to 6C are views illustrating examples of simulated magnetic fields generated by various types of wireless power transmission modules.

FIG. 7 is a schematic perspective view of another example of a wireless power transmission module.

FIG. 8 is a cross-sectional view taken along the line VIII-VIII′ of FIG. 7.

FIG. 9 is a schematic perspective view of another example of a wireless power transmission module.

FIG. 10 is a cross-sectional view taken along the line X-X′ of FIG. 9.

FIG. 11 is a schematic perspective view of another example of a wireless power transmission module.

FIG. 12 is a cross-sectional view taken along the line XII-XII′ of FIG. 11.

FIG. 13 is a schematic perspective view of another example of a wireless power transmission module.

FIG. 14 is a cross-sectional view taken along the line XIV-XIV′ of FIG. 13.

FIG. 15 is a schematic cross-sectional view of another example of a wireless power transmission module.

FIG. 16 is a schematic cross-sectional view of another example of a wireless power transmission module.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent to after an understanding of the disclosure of this application, with the exception of operations necessarily occurring in a certain order. Also, descriptions of functions and constructions that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

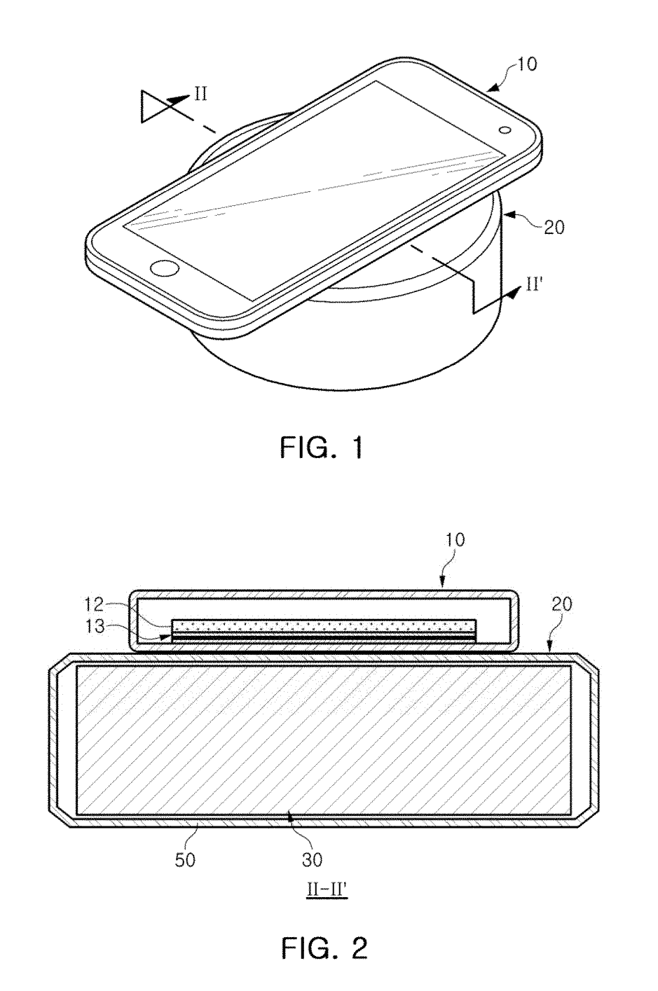

FIG. 1 is a schematic perspective view of examples of an electronic device. FIG. 2 is a cross-sectional view taken along the line II-II′ of FIG. 1.

Referring to FIGS. 1 and 2, one example of an electronic device is a wireless power transmission device wirelessly transmitting power, and another example of an electronic device is a wireless power receiving device wirelessly receiving power to be stored. An example of a wireless power transmission device is a charging device 20, and an example of a wireless power receiving device is a portable terminal 10 receiving power to be stored from the charging device 20.

The charging device 20 will now be described as an example of an electronic device.

However, the electronic device is not limited to a portable terminal or a charging device of the portable terminal. The electronic device may be any electronic device to which a wireless charging technology is applied, such as various household appliances that can be wirelessly charged and a wireless charging device thereof, as well as an electric vehicle that can be wirelessly charged and a wireless charging device thereof.

The charging device 20 charges a battery 12 of the portable terminal 10 by wirelessly transmitting power to a wireless power receiving module 13 of the portable terminal 10.

A wireless power transmission module 30 of the charging device 20 converts alternating current (AC) power for household use supplied from an external source to direct current (DC) power, or DC power supplied directly from an external source, and converts the DC power into AC power having a wireless power transmission frequency to wirelessly transmit power to the wireless power receiving module.

The charging device 20 includes a case 50 and the wireless power transmission module 30.

The case 50 may be made of an insulating resin material, and protects components accommodated therein from an external environment.

The case 50 may have various forms, such as a flat cylindrical form or a rectangular form, as long as the case 50 includes an accommodation space to accommodate the wireless power transmission module 30 therein.

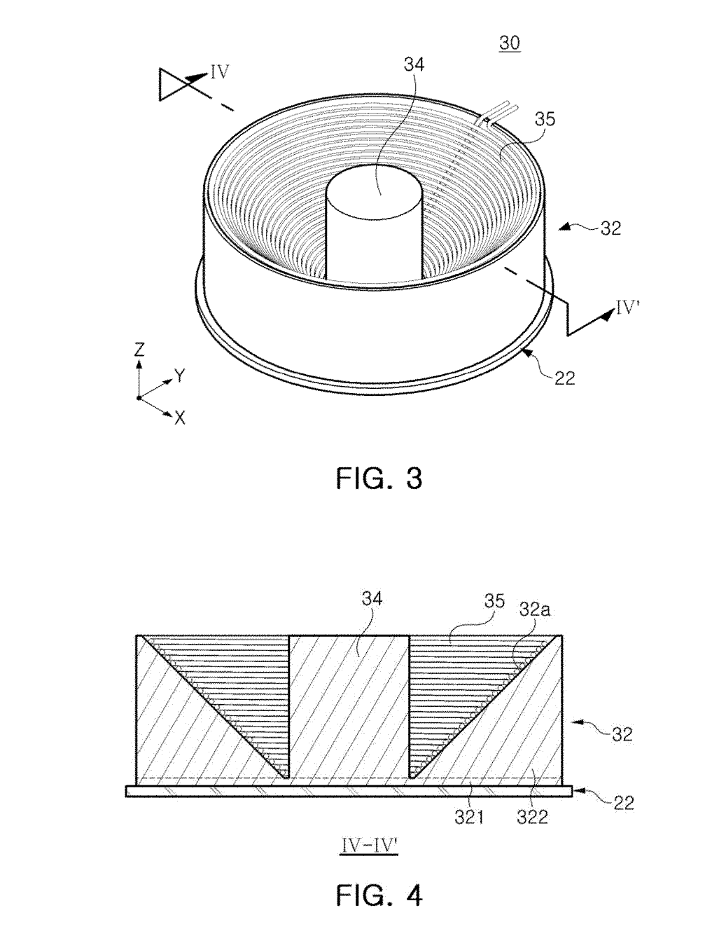

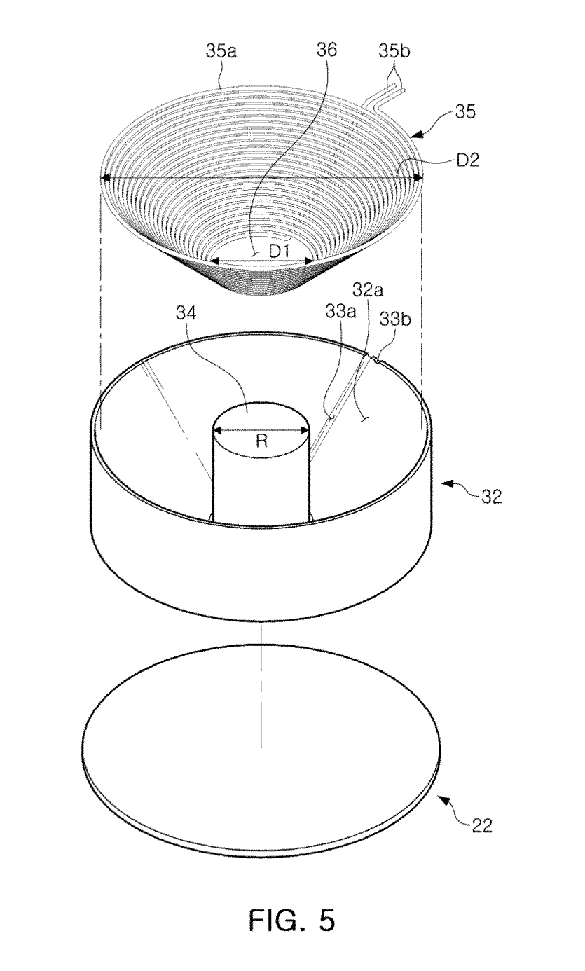

FIG. 3 is a schematic perspective view of an example of a wireless power transmission module. FIG. 4 is a cross-sectional view taken along the line IV-IV′ of FIG. 3. FIG. 5 is an exploded perspective view of the wireless power transmission module illustrated in FIG. 3.

Referring to FIGS. 3 to 5, a wireless power transmission module 30 includes a coil portion 35 and a magnetic portion 32.

The coil portion 35 includes at least one wound coil. In one example, a coil of the coil portion 35 is wound to have a solenoid form in which an upper end and a lower end of the coil have different internal diameters, or to have a spiral form in which a diameter is reduced in a direction toward an end of the coil, in a manner similar to a conch.

An insulated wire may be used to wind the coil. For example, a polyurethane-insulated wire or a multiple insulated wire (e.g., a triple insulated wire (TIW)) may be used to wind the coil.

A wire having a single strand or a stranded wire formed by twisting several strands (e.g., a litz wire) may be used to wind the coil.

However, the coil portion 35 is not limited to the composition described above. For example, a rectangular wire (i.e., a wire that is flat rather than round) may be used to wind an edgewise coil or a flat coil. Other modifications are also possible. For example, the coil portion 35 may be a coil substrate in which a coil pattern is formed on a substrate.

The coil portion 35 includes a spiral portion 35a wound to have a spiral form, and an outlet portion 35b extending from opposite ends of the spiral portion 35a to exit from the magnetic portion 32. The outlet portion 35b is electrically connected to a voltage converting portion 22 to be described later.

The spiral portion 35a is wound to have a spiral form (or a solenoid form) so that a lower end and an upper end of the spiral portion 35a have different internal diameters D1 and D2, respectively. The spiral portion 35a includes a hollow portion 36, which is an empty space formed in a central portion of the spiral portion 35a. Thus, the spiral portion 35a has a form in which opposite ends are spaced apart from each other by a specific distance, and the hollow portion 36 has a relatively small internal diameter.

A magnetic field concentration portion 34 to be described later is inserted into the hollow portion 36. Thus, the hollow portion 36 is formed to have a size sufficient for the magnetic field concentration portion 34 to be easily inserted thereinto.

The spiral portion 35a of the coil portion 35 has a conical form matching a form of a coil accommodation portion 32a of the magnetic portion 32 to be described later.

The coil portion 35 is inserted into the coil accommodation portion 32a of the magnetic portion 32 and combined with the magnetic portion 32 so that the coil portion 35 contacts the magnetic portion 32. Thus, the spiral portion 35a is disposed to contact an internal surface of the coil accommodation portion 32a, so the spiral portion 35a is formed to match the form of the coil accommodation portion 32a.

The coil portion 35 externally transmits electrical energy supplied by the voltage converting portion 22 to be described later.

When AC power from a commercial AC power source (or external DC power) is transformed to AC power having a wireless power transmission frequency by the voltage converting portion 22 and the AC power having the wireless power transmission frequency is applied to the coil portion 35, a changing magnetic field generated on a periphery of the coil portion 35. Thus, in the wireless power receiving module 13 of the portable terminal 10 disposed adjacent to the coil portion 35, an electromagnetic induction voltage is generated by the changing magnetic field, thereby charging the battery 12 of the portable terminal 10.

The magnetic portion 32 is disposed to efficiently form a magnetic path for a magnetic field generated by the coil portion 35. To this end, the magnetic portion 32 is made of a magnetic material in which the magnetic path may be easily formed, and, for example, may be formed by sintering a ferrite powder. However, this is merely an example, and the magnetic portion is not limited thereto. In addition to ferrite, other materials, such as silicon (Si) steel, an amorphous ribbon, a nanocrystalline ribbon, and a composite polymer made from a metal soft magnetic material, may be selectively used.

The magnetic portion 32 has a cylindrical body and includes the coil accommodation portion 32a having a form of a hollow space, and the magnetic field concentration portion 34 protruding from a central portion of the coil accommodation portion 32a.

A body of the magnetic portion 32 includes a base portion 321 and a sidewall portion 322.

The base portion 321 forms a bottom surface of the magnetic portion 32, and is a portion disposed on a bottom surface of the coil accommodation portion 32a. The bottom surface of the coil accommodation portion 32a is an internal surface of the coil accommodation portion 32a disposed farthest from an upper surface of the magnetic portion 32.

The sidewall portion 322 extends upwardly along a perimeter of the base portion 321 to form a side surface of the coil accommodation portion 32a. Thus, the coil accommodation portion 32a has a specific form determined by the base portion 321 and the sidewall portion 322.

In one example, an internal surface of the sidewall portion 322 is an inclined surface, and an external surface of the sidewall portion 322 is a vertical surface. However, this is merely an example, and the sidewall portion 322 may have other shapes.

The coil accommodation portion 32a has a form of a hollow space to accommodate the coil portion 35, and is formed in the upper surface of the magnetic portion 32.

The coil accommodation portion 32a is formed as a hollow space having a bowl form having a greatest width (or diameter) at the upper surface of the magnetic portion 32. Thus, the coil accommodation portion 32a is formed as a hollow space having a form in which an internal diameter of the hollow space gradually decreases in a direction toward a bottom side of the hollow space.

In the example illustrated in FIGS. 3 to 5, the coil accommodation portion 32a has a conical form. However, this is merely an example, and the coil accommodation portion 32a may have other forms, such as a parabolic form.

At least one outlet groove 33a is formed in the coil accommodation portion 32a.

The outlet groove 33a is formed as a linear groove connecting the bottom surface of the coil accommodation portion 32a to an entrance portion of the coil accommodation portion 32a.

The outlet portion 35b disposed on an internal side of the coil portion 35, i.e., between the coil portion 35 and the magnetic portion 32, is inserted into the outlet groove 33a. Thus, a width and a depth of the outlet groove 33a are formed to be greater than or equal to a diameter of the outlet portion 35b of the coil portion 35 so that the outlet portion 35b may be perfectly inserted into the outlet groove 33a.

The outlet groove 33a enables the outlet portion 35b of the coil portion 35 to exit from the coil accommodation portion 32a without being blocked by the spiral portion 35a.

In addition, an insertion groove 33b is formed in the entrance portion of the coil accommodation portion 32a to accommodate the outlet portion 35b disposed on an external side of the coil portion 35.

In the same manner as the outlet groove 33a, the insertion groove 33b is formed to have a width and a depth greater than or equal to a diameter of the outlet portion 35b so that the outlet portion 35b may be perfectly inserted into the insertion groove 33b. However, this is merely an example, and the insertion groove 33b may have other configurations, or may be omitted.

The magnetic field concentration portion 34 has a pillar form and protrudes from a central portion of the bottom surface of the coil accommodation portion 32a. A height of the magnetic field concentration portion 34 may be equal to a depth of the coil accommodation portion 32a. Thus, an end portion of the magnetic field concentration portion 34 may be coplanar with the upper surface of the magnetic portion 32 in which the coil accommodation portion 32a is formed.

The magnetic field concentration portion 34 is inserted into the hollow portion 36 formed in a central portion of the coil portion 35. Thus, the magnetic field concentration portion 34 is formed to have a size sufficient for the magnetic field concentration portion 34 to be inserted into the hollow portion 36 of the coil portion 35 when the coil portion 35 is combined with the magnetic portion 32.

The magnetic field concentration portion 34 has an external diameter R that is equal to or smaller than a diameter D1 of the lower end of the hollow portion 36 of the coil portion 35.

In the example of FIGS. 3 to 5, the magnetic field concentration portion 34 has a cylindrical pillar form matching a form of the hollow portion 36 of the coil portion 35. However, this is just an example, and the magnetic field concentration portion 34 may have other forms. For example, the magnetic field concentration portion 34 may have a rectangular pillar form or a triangular pillar form.

At least a portion of the hollow portion 36 of the coil portion 35 may contact an outer circumferential surface of the magnetic field concentration portion 34 and may be combined with the magnetic field concentration portion 34. In addition, a portion of the coil portion 35 may be wound around at least a portion of the magnetic field concentration portion 34.

The magnetic field concentration portion 34 causes a magnetic field generated by the wireless power transmission module 30 to be emitted from the end portion (or an upper end) of the magnetic field concentration portion 34. Since the magnetic field is emitted in a position closest to a portable terminal 10 of FIGS. 1 and 2 receiving electrical energy, the wireless power transmission module 30 may be easily electromagnetically coupled to the wireless power receiving module 13 disposed in the portable terminal 10.

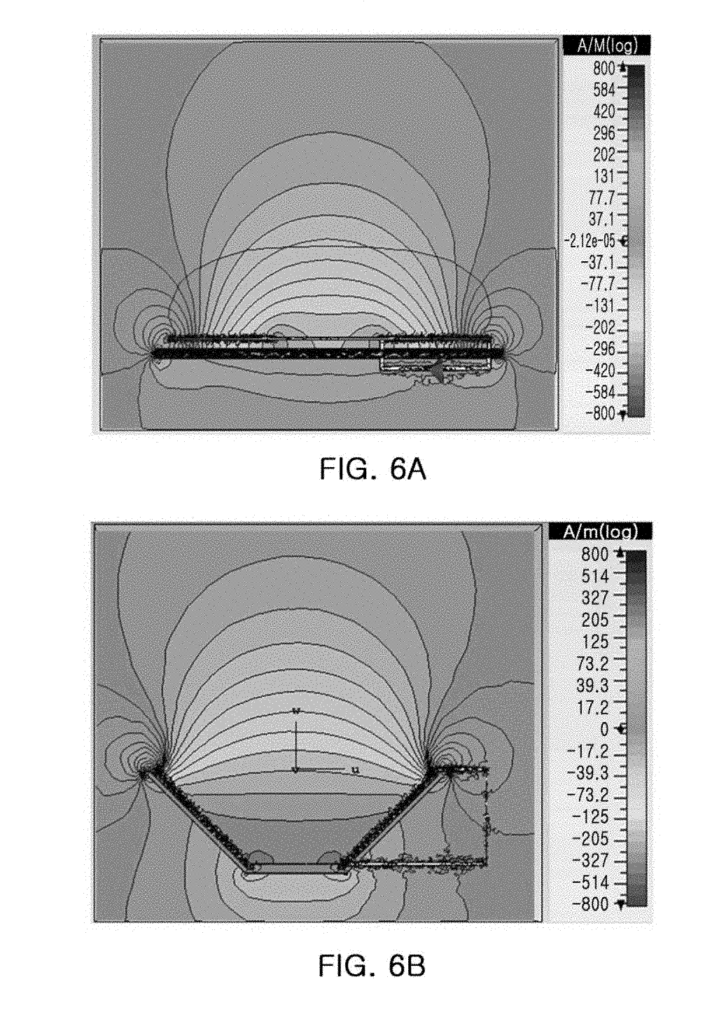

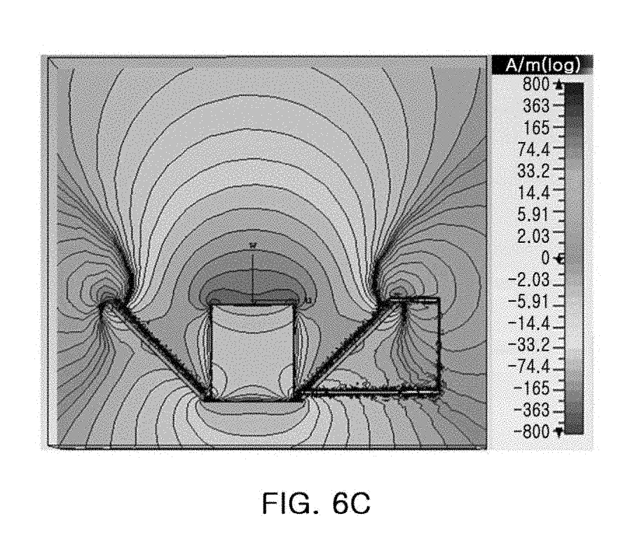

FIGS. 6A to 6C are views illustrating examples of simulated magnetic fields generated by various types of wireless power transmission modules.

FIG. 6A is a view illustrating an example of a simulated magnetic field generated by a planar wireless power transmission module of the related art. FIG. 6B is a view illustrating an example of a simulated magnetic field generated by the wireless power transmission module 30 of FIGS. 3 to 5 from which the magnetic field concentration portion 34 has been removed. FIG. 6C is a view illustrating an example of a simulated magnetic field generated by the wireless power transmission module 30 of FIGS. 3 to 5. In FIGS. 6A to 6C, different colors indicate different strengths (A/m) of the simulated magnetic field.

When the portable terminal of FIGS. 1 and 2 is being charged by the wireless power transmission module 30, the wireless power receiving module 13 of the portable terminal is disposed near the end portion of the magnetic field concentration portion 34. Thus, the magnetic flux of the magnetic field generated by the wireless power transmission module 30 should be concentrated at an external side of the end portion of the magnetic field concentration portion 34, rather than in the coil accommodation portion 32a.

Referring to FIG. 6C, it can be confirmed that in the wireless power transmission module 30 of FIGS. 3 to 5, a magnetic field is concentrated at the external side of the end portion of the magnetic field concentration portion 34, rather than in the coil accommodation portion 32a. In addition, it can be that a magnetic field extends a relatively long distance way from the magnetic field concentration portion 34.

In contrast, referring to FIG. 6A, it can be confirmed that in the planar wireless power transmission module of the related art, the strength of an overall magnetic field is lower than the magnetic field generated by the wireless power transmission module 30 of FIGS. 3 to 5, and the magnetic field is formed only on a periphery of the planar wireless power transmission module of the related art.

In addition, referring to FIG. 6B, it can be confirmed that when the magnetic field concentration portion 34 in the example of FIGS. 3 to 5 is removed, the strength of a magnetic field in a Z-axis direction of FIG. 3 is decreased to be significantly lower than the strength of the magnetic field of FIG. 6C. Thus, a wireless power transmission module having the structure illustrated in FIG. 6B may be used to enable the wireless power receiving module 13 to be disposed in an internal space of a coil accommodation portion. However, it can be seen that if the wireless power receiving module 13 is disposed on the wireless power transmission module having the structure illustrated in FIG. 6B in the same manner as in the example of FIGS. 3 to 5, a charging efficiency is significantly reduced.

Thus, wireless power transmission module 30 of FIGS. 3 to 5 enables a magnetic field to be concentrated in the magnetic field concentration portion 34 using a coil portion 35 having a conical form. A magnetic field strength in the Z-axis direction is strengthened by the magnetic field concentration portion 34, thereby forming a magnetic field at a relatively long distance from the wireless power transmission module 30. Thus, even if the wireless power receiving module 13 is disposed at a relatively long distance from the wireless power transmission module 30, the wireless power receiving module 13 may still receive electrical energy from the wireless power transmission module 30, so that a charging efficiency may be improved.

An entirety of the magnetic portion 32 in the example of FIGS. 3 to 5 may be made of a same material. Alternatively, the magnetic field concentration portion 34 may be made of a material that is different from the material of either one or both of the base portion 321 or the sidewall portion 322. For example, the magnetic field concentration portion 34 may be made of a material having a higher magnetic permeability than the material of either one or both of the base portion 321 and the sidewall portion 322. However, this is merely an example, and there may be other differences between the materials of the magnetic field concentration portion 34 and either one or both of the base portion 321 and the sidewall portion 322.

The wireless power transmission module 30 further includes a voltage converting portion 22.

The voltage converting portion 22 converts household AC power supplied from an external source into DC power, or receives DC power directly from an external source, and converts the DC power into an AC voltage having a wireless power transmission frequency to be supplied to the coil portion 35.

The voltage converting portion 22 may be a circuit board on which electronic components are mounted, but is not limited thereto.

In order to block electromagnetic waves or magnetic flux, a shielding sheet (not illustrated), such as an aluminum (Al) sheet, may be added between the magnetic portion 32 and the voltage converting portion 22 if necessary.

Although specific examples have been described above, various changes and modifications may be made in these examples.

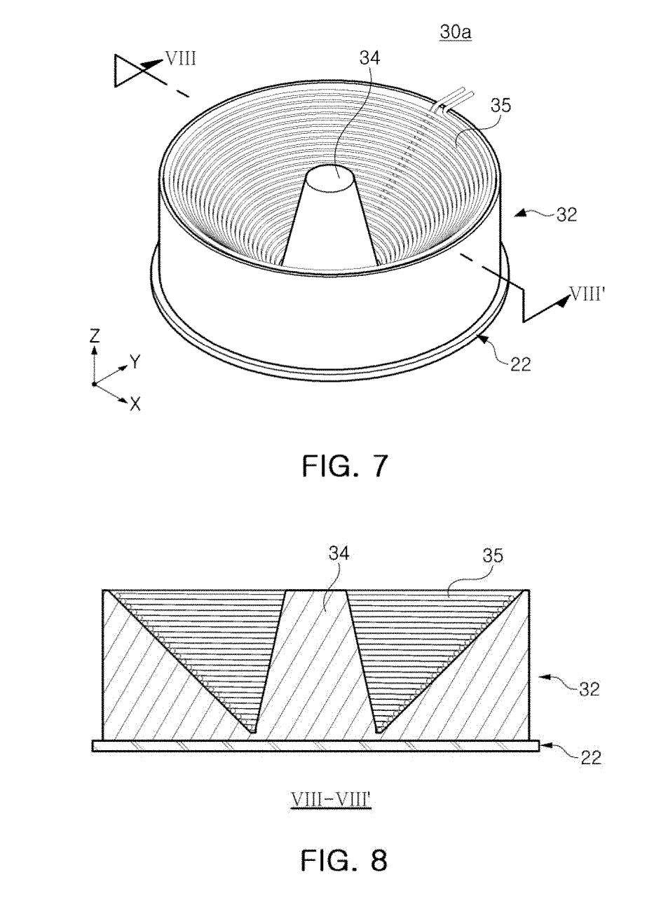

FIG. 7 is a schematic perspective view of another example of a wireless power transmission module. FIG. 8 is a cross-sectional view taken along the line VIII-VIII′ of FIG. 7.

Referring to FIGS. 7 and 8, a wireless power transmission module 30a includes a magnetic field concentration portion 34 having a conical form in which a cross-sectional area of the magnetic field concentration portion 34 gradually decreases in a direction toward an end portion of the magnetic field concentration portion 34 having a flat surface.

Since a magnetic field is concentrated in a relatively small area of the end portion of the magnetic field concentration portion 34 in the example of FIGS. 7 and 8 as compared with the example of FIGS. 3 to 5 described above, a range of the magnetic field may be further expanded in a Z direction. Thus, since a charging distance is extended, efficient charging is possible, even when a wireless power receiver is disposed relatively far from a wireless power transmission module.

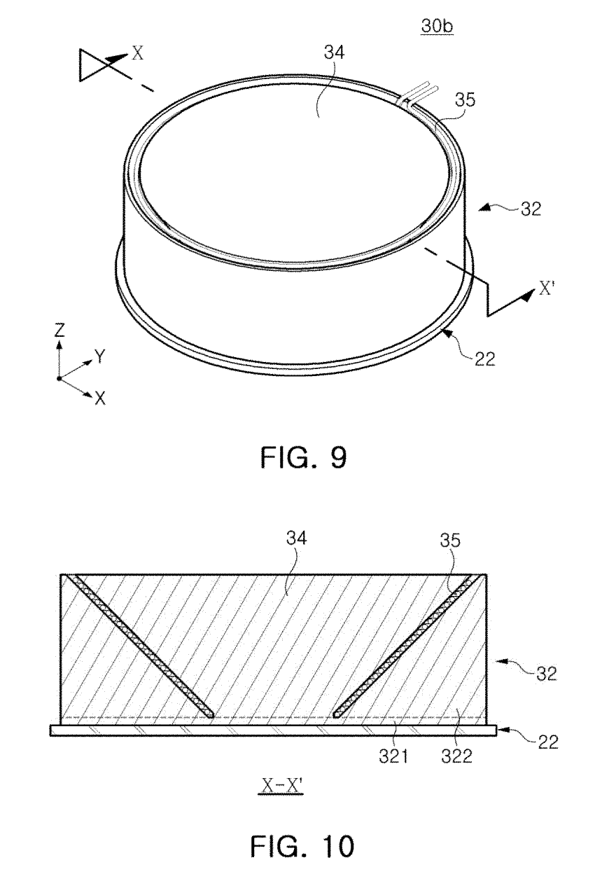

FIG. 9 is a schematic perspective view of another example of a wireless power transmission module. FIG. 10 is a cross-sectional view taken along the line X-X′ of FIG. 9.

Referring to FIGS. 9 and 10, a wireless power transmission module 30b includes a magnetic field concentration portion 34 having a conical form in which a cross-sectional area of the magnetic field concentration portion 34 gradually increases in a direction toward an end portion of the magnetic field concentration portion 34 having a flat surface.

Since an area of the end portion of the magnetic field concentration portion 34 in the example of FIGS. 9 and 10 is greater than in the examples of FIGS. 3 to 5, 7, and 8, a magnetic field is formed within a wider range (in X and Y directions) than in the examples of FIGS. 3 to 5, 7, and 8, thereby expanding a charging range. Since a charging range is expanded, efficient charging is possible, even when a wireless power receiver is not disposed at a correct charging position.

In the wireless power transmission module 30b in the example of FIGS. 9 and 10, it is difficult to interpose a coil portion 35 between the magnetic field concentration portion 34 and a sidewall portion 322 of a magnetic portion 32 due to the form of the magnetic field concentration portion 34. Thus, to enable the coil portion 35 to be interposed between the magnetic field concentration portion 34 and the sidewall portion 322, the magnetic field concentration portion 34 and the remainder of the magnetic portion 32 (e.g., a base portion 321 and the sidewall portion 322) may be separately manufactured, and the magnetic field concentration portion 34 may be combined with the base portion 321 after the coil portion 35 has been placed onto the sidewall portion 322. In the resulting structure of the wireless power transmission module 30b, the magnetic field concentration portion 34 fills substantially an entire volume of a coil accommodation portion not occupied by the coil portion 35.

In the wireless power transmission module 30b of FIGS. 9 and 10, a form of the magnetic field concentration portion 34 is changed to adjust a range of a magnetic field. Thus, the examples of a wireless power transmission module described above may be applied to various electronic devices having a wireless charging capability.

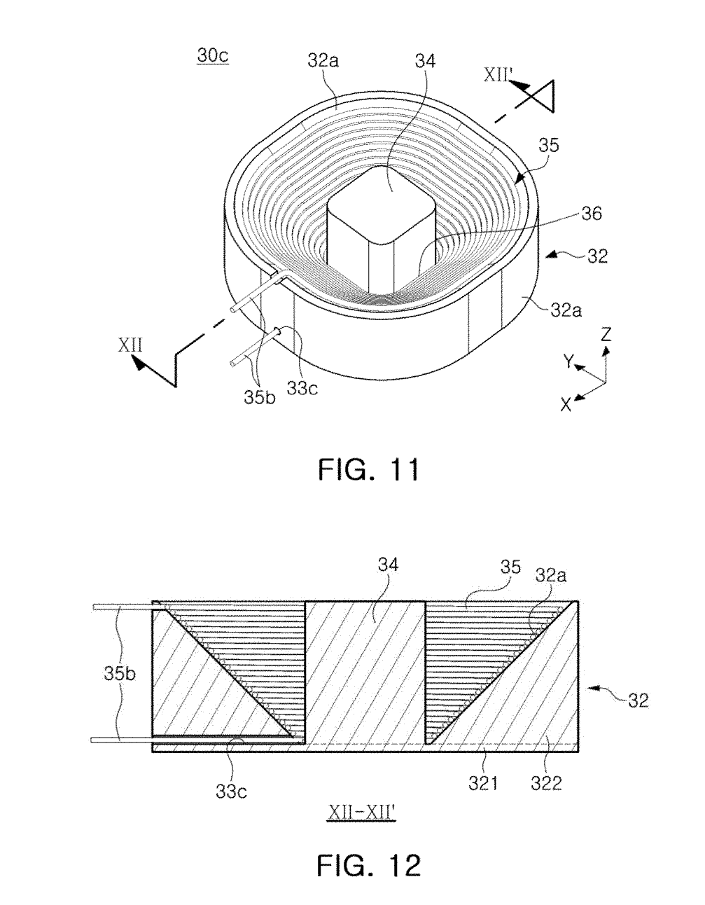

FIG. 11 is a schematic perspective view of another example of a wireless power transmission module. FIG. 12 is a cross-sectional view taken along the line XII-XII′ of FIG. 11.

Referring to FIGS. 11 and 12, a wireless power transmission module 30c includes a magnetic portion 32 and a magnetic field concentration portion 34 having a form of a rectangular pillar having rounded edges. A hollow portion 36 of a coil portion 35 disposed in a coil accommodation portion 32a of the magnetic portion 32 has a form of a rectangular groove having rounded edges.

In addition, an outlet hole 33c, rather than an outlet groove, is formed in the magnetic portion 32.

The outlet hole 33c penetrates through a sidewall portion 322 in the direction of the diameter of the magnetic portion 32 to the outside of the magnetic portion 32 at a position adjacent to a base portion 321. One end of the outlet hole 33c is connected to the coil accommodation portion 32a, while the other end is disposed on an external side surface of the sidewall portion 322.

Thus, an outlet portion 35b disposed on an internal side of the coil portion 35 exits from an external side of the sidewall portion 322 through the outlet hole 33c.

In the example illustrated in FIG. 11, the outlet hole 33c is formed to be parallel to an X-Y plane in a direction perpendicular to the magnetic field concentration portion 34. However, the configuration of the outlet hole 33c is not limited to this example, and various modifications are possible. For example, the outlet hole 33c may be formed to be inclined relative to the X-Y plane.

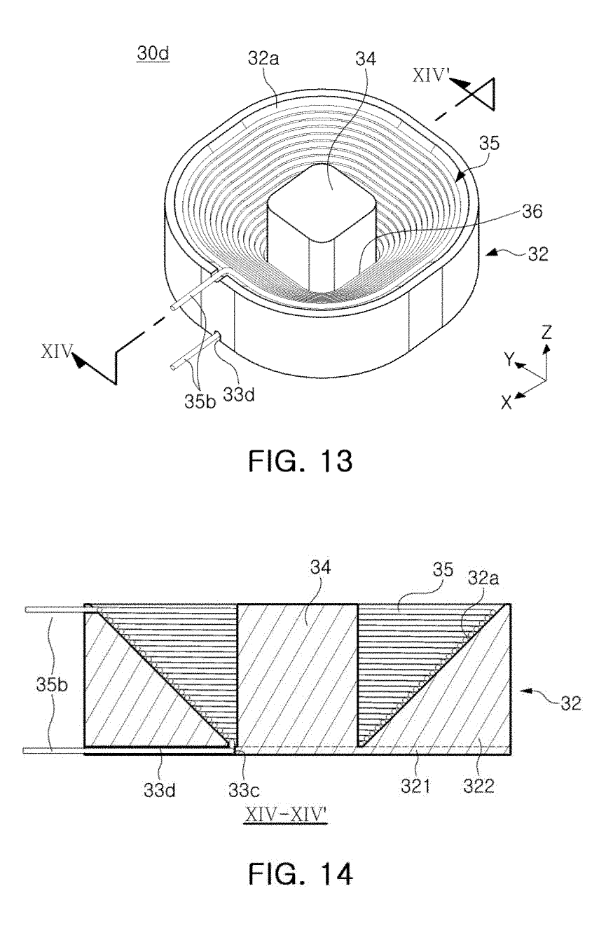

FIG. 13 is a schematic perspective view of another example of a wireless power transmission module. FIG. 14 is a cross-sectional view taken along the line XIV-XIV′ of FIG. 13.

Referring to FIGS. 13 and 14, a wireless power transmission module 30d has a form similar to the form of the wireless power transmission module 30c illustrated in FIGS. 11 and 12. The wireless power transmission module 30d is different from the wireless power transmission module 30c in terms of the location an outlet hole 33c.

The outlet hole 33c in the example of FIGS. 13 and 14 penetrates through a base portion 321 of a coil accommodation portion 32a. One end of the outlet hole 33c is connected to the coil accommodation portion 32a, while the other end is disposed on a bottom surface of a magnetic portion 32.

Thus, an outlet portion 35b disposed on an internal side of a coil portion 35 exits from a lower portion of the magnetic portion 32 through the outlet hole 33c.

The outlet hole 33c is disposed adjacent to a magnetic field concentration portion 34 so that the outlet portion 35b disposed on the internal side of the coil portion 35 may easily exit through the outlet hole 33c.

In addition, a guide groove 33d is formed in the bottom surface of the magnetic portion 32 so that the outlet portion 35b exiting from the lower portion of the magnetic portion 32 exits from an external side surface of the magnetic portion 32.

The guide groove 33d extends from the outlet hole 33c in the direction of the diameter of the magnetic portion 32 to the outside of the magnetic portion 32. Thus, the guide groove 33d is formed as a groove portion connecting the outlet hole 33c to an outer circumferential surface of a sidewall portion 322.

In addition, the guide groove 33d is formed to have a width and a depth sufficient for the outlet portion 35b to be perfectly inserted thereinto. Thus, the outlet portion 35b exiting from the lower portion of the magnetic portion 32 through the outlet hole 33c is inserted into the guide groove 33d and ends up exiting from the side surface of the magnetic portion 32.

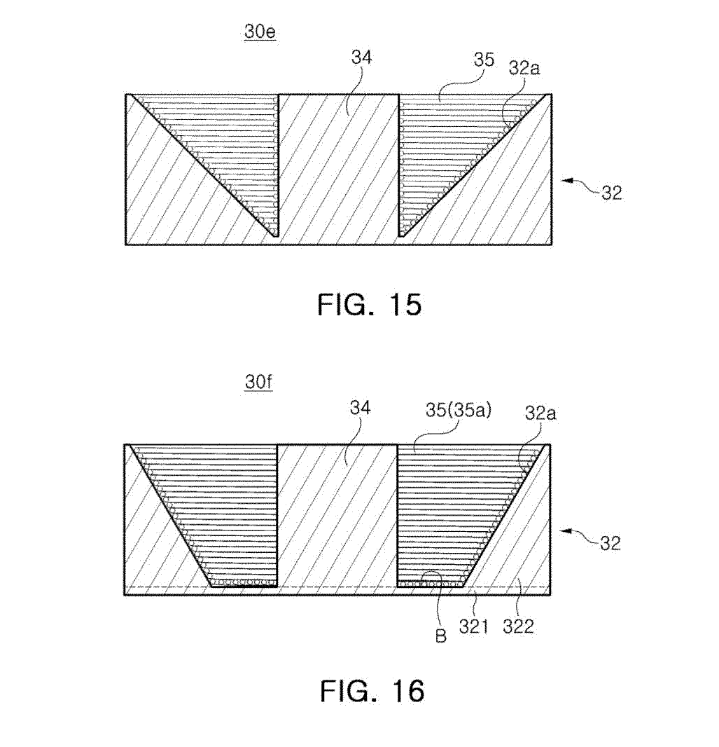

FIG. 15 is a schematic cross-sectional view of another example of a wireless power transmission module.

Referring to FIG. 15, a wireless power transmission module 30e has a structure in which a portion of a coil portion 35 is disposed on an internal surface of a coil accommodation portion 32a, a remainder of the coil portion 35 is wound around an outer circumferential surface of a magnetic field concentration portion 34.

In the example illustrated in FIG. 15, the remainder of the coil portion 35 is wound around an entirety of the outer circumferential surface of the magnetic field concentration portion 34. However, in an another example, the remainder of the coil portion 35 is wound around only a portion of the outer circumferential surface of the magnetic field concentration portion 34.

FIG. 16 is a schematic cross-sectional view of another example of a wireless power transmission module.

Referring to FIG. 16, a wireless power transmission module 30f includes a coil accommodation portion 32a having an inclined conical portion and a flat bottom surface B. A spiral portion 35a of a coil portion 35 includes an inclined conical portion disposed on the inclined conical portion of the coil accommodation portion 32a and a planar portion disposed on the flat bottom surface B of the coil accommodation portion 32a.

The examples of a wireless power transmission module described above generate a magnetic field at a relatively long distance from the wireless power transmission module by strengthening a magnetic field in a Z-axis direction and increase a charging area, thereby improving a charging efficiency.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit were to be combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wireless power transmission module comprising:
a coil portion having a spiral form and comprising a hollow portion; and
a magnetic portion comprising:
a coil accommodation portion in which the coil portion is disposed, the coil accommodation portion being formed as a hollow space in an upper surface of the magnetic portion, and having a bowl form having a greatest width at the upper surface of the magnetic portion; and
a magnetic field concentration portion protruding upwardly from a central portion of the coil accommodation portion through the hollow portion of the coil portion.

2. The wireless power transmission module of claim 1, wherein an end portion of the magnetic field concentration portion is coplanar with the upper surface of the magnetic portion.

3. The wireless power transmission module of claim 1, wherein at least a portion of the coil portion is disposed on an internal surface of the coil accommodation portion.

4. The wireless power transmission module of claim 3, wherein a portion of the coil portion is wound around at least a portion of an outer circumferential surface of the magnetic field concentration portion.

5. The wireless power transmission module of claim 1, wherein a cross-sectional area of the magnetic field concentration portion increases or decreases in a direction toward an end portion of the magnetic field concentration portion.

6. The wireless power transmission module of claim 1, wherein the magnetic portion comprises:
a base portion forming a bottom of the coil accommodation portion; and
a sidewall portion disposed along a perimeter of the base portion and forming an external side surface of the coil accommodation portion.

7. The wireless power transmission module of claim 6, wherein the coil portion comprises:
a spiral portion having a spiral form; and
an outlet portion extending from opposite ends of the spiral portion and exiting from the magnetic portion; and
the magnetic portion comprises either one or both of an outlet groove and an outlet hole enabling the outlet portion to exit from the magnetic portion.

8. The wireless power transmission module of claim 7, wherein the outlet hole penetrates through the sidewall portion of the magnetic portion.

9. The wireless power transmission module of claim 7, wherein the outlet hole penetrates through the base portion of the magnetic portion.

10. The wireless power transmission module of claim 9, further comprising a guide groove formed in a bottom surface of the magnetic portion and connecting the outlet hole to an outer circumferential surface of the sidewall portion.

11. The wireless power transmission module of claim 6, wherein a material of the magnetic field concentration portion is different from either one or both of a material of the base portion and a material of the sidewall portion.

12. The wireless power transmission module of claim 1, wherein the coil accommodation portion comprises an inclined side surface and a flat bottom surface.

13. The wireless power transmission module of claim 1, wherein the magnetic field concentration portion comprises a flat end portion.

14. A wireless power transmission module comprising:
a coil portion having a solenoid form and comprising a hollow portion, wherein an upper end and a lower end of the coil portion have different internal diameters; and
a magnetic portion combined with the coil portion and comprising a magnetic field concentration portion combined with the coil portion and having a pillar form penetrating through the hollow portion of the coil portion. wherein a height of the magnetic field concentration portion is equal to a height of the coil portion.

15. An electronic device comprising:
a case; and
a wireless power transmission module disposed in the case and comprising:
a coil portion having a solenoid form and comprising a hollow portion, wherein an upper end and a lower end of the coil portion have different internal diameters; and
a magnetic portion comprising:
a coil accommodation portion in which the coil portion is disposed, the coil accommodation portion being formed as a hollow space in an upper surface of the magnetic portion, and having a bowl form having a greatest width at the upper surface of the magnetic portion; and
a magnetic field concentration portion protruding upwardly from a central portion of the coil accommodation portion through the hollow portion of the coil portion.

16. The electronic device of claim 15, wherein a portion of the coil portion is wound around at least a portion of an outer circumferential surface of the magnetic field concentration portion.

17. A wireless power transmission module comprising:
a magnetic portion comprising:
a coil accommodation portion formed as a hollow space in an upper surface of the magnetic portion, wherein a cross-sectional area of the hollow space increases in a direction from a bottom of the hollow space to the upper surface of the magnetic portion; and
a magnetic field concentration portion disposed on a bottom surface of the coil accommodation portion; and
a coil portion disposed on a surface of the coil accommodation portion without covering an upper end of the magnetic field concentration portion.

18. The wireless power transmission module of claim 17, wherein the hollow space has a conical form in which a diameter of the hollow space linearly increases from the bottom of the hollow space to the upper surface of the magnetic portion.

19. The wireless power transmission module of claim 17, wherein a cross-sectional area of the magnetic field concentration portion increases or decreases from a lower end of the magnetic field concentration portion disposed on the bottom surface of the coil accommodation portion to an upper end of the magnetic field concentration portion.

20. The wireless power transmission module of claim 17, further comprising a voltage converting portion configured to convert AC or DC power received from an external source to AC power having a wireless power transmission frequency, and apply the AC power having the wireless power transmission frequency to the coil portion to transmit wireless power.
